(19) United States
(12) Patent Application Publication
(10) Pub. No.: US 2006/0137898 A1
(43) Pub. Date: Jun. 29, 2006

(54) Electrical cables

(76) Inventors: Byong Jun Kim, Sugar Land, TX (US); Joseph Varkey, Missouri City, TX (US)

Correspondence Address: SCHLUMBERGER CONVEYANCE AND DELIVERY;ATTN: ROBIN NAVA, 555 INDUSTRIAL BOULEVARD, MD-1, SUGAR LAND, TX, 77478, US

(21) Appl. No.: 11/361,572

(22) Filed: Feb. 24, 2006

Related U.S. Application Data
(62) Division of application No. 10/952,089, filed on Sep. 28, 2004.

(51) Int. Cl. H01B 7/00

(52) U.S. Cl. 174/120 R

(57) ABSTRACT

An electrical cable is provided which includes an electrical conductor, a first insulating jacket disposed adjacent the electrical conductor and having a first relative permittivity, wherein the first insulating jacket is prepared from an admixture of: a polymer selected from the group consisting of polyaryletherether ketone polymer, polyphenylene sulfide polymer, polyether ketone, maleic anhydride modified polymers, Parmax® SRP polymers, and any mixtures thereof; and, a fluoropolymer additive. A second insulating jacket disposed adjacent the first insulating jacket and having a second relative permittivity that is less than the first relative permittivity, and wherein the insulating jacket is mechanically bonded to the second insulating jacket. In another aspect of the present invention, a method is provided for manufacturing a cable that includes providing an electrical conductor, extruding a first insulating jacket over the electrical conductor, and extruding a second insulating jacket thereon.

### BACKGROUND OF THE INVENTION

1. Field of the Invention

This invention relates to an electric field suppressing cable and a method of manufacturing same. In one aspect, the invention relates to an electric field suppressing cable used with devices to analyze geologic formations adjacent a well before completion and a method of manufacturing same.

2. Description of the Related Art

Generally, geologic formations within the earth that contain oil and/or petroleum gas have properties that may be linked with the ability of the formations to contain such products. For example, formations that contain oil or petroleum gas have higher electrical resistivity than those that contain water. Formations generally comprising sandstone or limestone may contain oil or petroleum gas. Formations generally comprising shale, which may also encapsulate oil-bearing formations, may have porosities much greater than that of sandstone or limestone, but, because the grain size of shale is very small, it may be very difficult to remove the oil or gas trapped therein.

Accordingly, it may be desirable to measure various characteristics of the geologic formations adjacent to a well before completion to help in determining the location of an oil- and/or petroleum gas-bearing formation as well as the amount of oil and/or petroleum gas trapped within the formation. Logging tools, which are generally long, pipe-shaped devices, may be lowered into the well to measure such characteristics at different depths along the well. These logging tools may include gamma-ray emitters/receivers, caliper devices, resistivity-measuring devices, neutron emitters/receivers, and the like, which are used to sense characteristics of the formations adjacent the well. A wireline cable connects the logging tool with one or more electrical power sources and data analysis equipment at the earth's surface, as well as providing structural support to the logging tools as they are lowered and raised through the well. Generally, the wireline cable is spooled out of a truck, over a pulley, and down into the well.

Wireline cables are typically formed from a combination of metallic conductors, insulative material, filler materials, jackets, and metallic armor wires. In the manufacture of cables, it is common to utilize extrusion processing to form an insulating jacket adjacent the conductor, or conductors, of the cable. In some cases, it may be desirable to form more than one insulative jacket adjacent the conductor(s) to achieve certain properties. U.S. Pat. No. 6,600,108 (Mydur et al.), incorporated by reference hereinafter, describes cables with two different insulative jackets formed around conductor(s) to provide a cable capable of conducting larger amounts of power with excellent electrical insulation, by reducing undesirable electrical effects induced in both the electrical power and data signals transmitted over the conductors of the cable. This design also avoids using the metallic armor as an electrical return conductor, as such configurations may present a hazard to personnel and equipment that inadvertently come into contact with the armor wires during operation of the logging tools.

Extrusion techniques are typically used to form insulative conductors with multiple insulative jackets. Examples of typical techniques known in the field to make multilayer insulated conductors are co-extrusion or tandem extrusion. In a tandem extrusion process, a first thin insulating jacket may be extruded, preferably compression extruded, directly around the metallic conductor(s), and after a finite period of time, a second jacket is extruded upon the first jacket. In order to form a cable useful for oilfield applications, insulated conductors are typically run in continuous lengths of up to about 12,000 meters so that the tools may be lowered over the entire depth of the well. While tandem extrusion is effective for forming such insulated conductors, it may be appreciated that processing related defects in the insulating jackets such as impurities trap between jackets, thickness variations, jacket smoothness, or even interfacial distortion between jackets is encountered. Such defects may be either repaired, or lead to degradation in cable performance. When repaired, manufacturing rated is generally slowed. In some situations, the extruded conductors with defects may not be repaired and should be scrapped. Also, consistent thickness and smoothness is particularly important for the first insulative jacket when preparing a stacked dielectric based cable, such as those described in U.S. Pat. No. 6,600,108.

Thus, a need exists for cables that are capable of conducting larger amounts of power while reducing undesirable electrical effects induced in both the electrical power and data signals transmitted over the conductors of the cable, which also avoids using the metallic armor as an electrical return conductor. Further, the need exists for a wireline cable wherein the insulative jackets disposed adjacent the conductors have consistent thicknesses and smoothness, as well as minimal interfacial distortion between jackets. A cable that can overcome one or more of the problems detailed above while conducting larger amounts of power with significant data signal transmission capability would be highly desirable, and the need is met at least in part by the following invention.

### BRIEF SUMMARY OF THE INVENTION

In one aspect of the present invention, an electrical cable is provided. The cable includes an electrical conductor, a first insulating jacket disposed adjacent the electrical conductor and having a first relative permittivity, wherein the first insulating jacket is prepared from an admixture of a polymer selected from the group consisting of polyaryletherether ketone polymer, polyphenylene sulfide polymer, polyether ketone, maleic anhydride modified polymers, Parmax® SRP polymers, and any mixtures thereof, and a fluoropolymer additive. A second insulating jacket disposed adjacent the first insulating jacket and having a second relative permittivity that is less than the first relative permittivity, and wherein the insulating jacket is mechanically bonded to the second insulating jacket.

In another aspect of the present invention, a method is provided for manufacturing a cable. The method includes providing an electrical conductor, extruding a first insulating jacket having a first relative permittivity over the electrical conductor, wherein the first insulating jacket is prepared from an admixture of a polymer from the group consisting of polyaryletherether ketone polymer, polyphenylene sulfide polymer, polyether ketone, maleic anhydride modified polymers, Parmax® SRP polymers, and any mixtures thereof; and, a fluoropolymer additive, and extruding a second insulating jacket having a second relative permittivity over the electrical conductor, wherein the second relative permittivity is less than the first relative permittivity.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is a stylized cross-sectional view of a first illustrative embodiment of a cable according to the present invention;

FIG. 2 is a stylized cross-sectional view of an insulated conductor of the cable shown in FIG. 1;

FIG. 3 is a stylized cross-sectional view of a second illustrative embodiment of a cable according to the present invention;

FIG. 4 is a stylized cross-sectional view of a third illustrative embodiment of a cable according to the present invention; and,

FIG. 5 is a flow chart of an illustrative method of manufacturing an electrical cable.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

An electrical voltage applied to an electrical conductor produces an electric field around the conductor. The strength of the electric field varies directly according to the voltage applied to the conductor. When the voltage exceeds a critical value (i.e., the inception voltage), a partial discharge of the electric field may occur. Partial discharge is a localized ionization of air or other gases near the conductor, which breaks down the air. In electrical cables, the air may be found in voids in material insulating the conductor and, if the air is located in a void very close to the surface of the conductor where the electric field is strongest, a partial discharge may occur. Such partial discharges are generally undesirable, as they progressively compromise the ability of the insulating material to electrically insulate the conductor. If the electric field generated by electricity flowing through the conductor can be at least partially suppressed, the likelihood of partial discharge may be reduced. U.S. Pat. No. 6,600,108 describes cables designed to suppress the electric field by forming multiple insulation jackets over the electrical conductors.

For electrical cables useful for downhole applications with two or more jackets of insulation it is desirable to manufacture continuous cable lengths up to about 12,000 meters. In the manufacture of such cables, the jackets should be formed with minimal variations in thickness, low occurrence of defects, good smoothness, as well as little or no interfacial distortion between jackets. Smoothness and minimal thickness variations are particularly critical when forming the first jacket. For better electrical field intensity distribution over a stranded conductor, it is beneficial that the first insulation jacket be a consistent layer of polymeric insulation with high polarity and a high dielectric constant.

It has been discovered that including a fluoropolymer additive in the material composition that forms a first jacket provides significant improvement for producing long cable lengths. When the fluoropolymer additive containing jacket is formed adjacent to the electrical conductors, the resulting cable has a smoother insulation surface with very uniform final diameter, and minimal defects over the long length of the electrical cable. It is also found that adding fluoropolymer allows the insulated conductor to be manufactured at faster rates.

A typical defect is a lump that forms in the extrusion of a first jacket. High polarity high dielectric constant polymers, such as polyaryletherether ketone (PEEK) polymer, polyphenylene sulfide (PPS) polymer, polyether ketone (PEK) polymer, maleic anhydride modified polymers, and Parmax® SRP polymers can have affinity to metallic extrusion die surfaces. When these polymers are extruded in thin layers, from about 0.051 mm to about 0.153 mm, around stranded metallic conductor wires, the polymer exhibits a tendency to stick to the die orifice and progressively accumulate. The accumulation can then thermally degrade on the die orifice, especially at high processing temperatures, for example, above 340° C. This accumulation of polymer around the orifice of the extrusion die may ultimately release and cause lumps in the insulation jacket. It is also believed that the spiral motion of polymer melt during the extrusion process to form insulated stranded conductors furthers the accumulation. The spiral flow of polymer melt results from high line speed of a stranded metal conductor. In a final produced cable, such lumps can lead to poor electrical field intensity distribution, formation of voids, and degradation in cable performance. Furthermore, when those polar polymers are compression extruded for the first layer and after a finite period of time, a second polymer is tandem-extruded upon the first jacket which has a lump or thermally degraded polymer, the conductor may not be repaired.

While this invention and its claims are not bound by any particular mechanism of operation or theory, it is believed that including a fluoropolymer additive with a peak melting point below the processing temperature, typically 340° C. or higher, neutralizes the polymer's affinity for the die surface. During the high temperature extrusion process, the fluoropolymer migrates to the surface of the jacket forming material, providing a barrier between the polymer and the die surface, thus eliminating the accumulation of the polar polymers. The lower surface energy of the fluoropolymer along with significant incompatibility and immiscibility of the fluoropolymer with the highly polar polymer may both be considered driving forces for migration.

As stated above, including a fluoropolymer additive may also provide a smoother insulative jacket surface. Rough surfaces can be caused by melt fracturing, where the polymer surface is distorted upon exiting the die orifice. Highly fluorinated fluoropolymers have low friction coefficients. As the fluoropolymer may migrate as described above, low friction between the mixture of polymer and fluoropolymer and the die surface is also possible. This perhaps may lead to such benefits as smoother insulative jacket surface, as well as increased production speed, and more consistent final diameter.

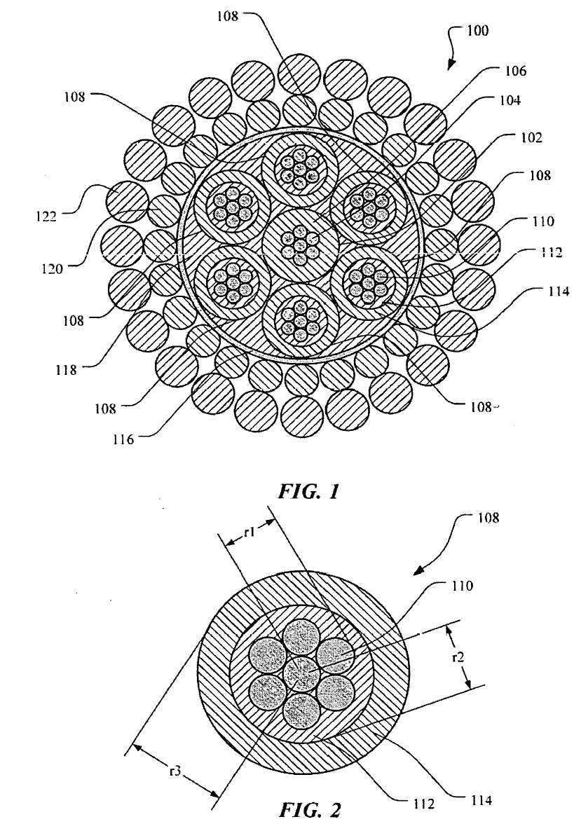

FIG. 1 depicts a first illustrative embodiment of a cable 100 according to the present invention. In the illustrated embodiment, the cable 100 includes a central insulated conductor 102 having a central conductor 104 and an insulating jacket 106. The cable 100 further includes a plurality of outer insulated conductors 108, each having an outer conductor 110 (only one indicated), a first insulating jacket 112 (only one indicated) and a second insulating jacket 114 (only one indicated).

One of the outer insulated conductors 108 of FIG. 1 is illustrated in FIG. 2. In the illustrated embodiment, the outer conductor 110 is shown as a stranded conductor but may alternatively be a solid conductor. For example, the outer conductor 110 may be a seven-strand copper wire conductor having a central strand and six outer strands laid around the central strand. Further, various dielectric materials have different relative permittivities, i.e., different abilities to permit the opposing electric field to exist, which are defined relative to the permittivity of a vacuum. Higher relative permittivity materials can store more energy than lower relative permittivity materials. In the illustrated embodiment, the first insulating jacket 112 is prepared from an admixture of a fluoropolymer additive and a high polar dielectric material having a relative permittivity within a range of about 2.5 to about 10.0, such as polyaryletherether ketone polymer, polyphenylene sulfide polymer, polyether ketone polymer, maleic anhydride modified polymers, and Parmax® SRP polymers (self-reinforcing polymers manufactured by Mississippi Polymer Technologies, Inc based on a substituted poly (1,4-phenylene) structure where each phenylene ring has a substituent R group derived from a wide variety of organic groups), or the like, and any mixtures thereof. A particulary useful polyphenylene sulfide polymer (PPS) dielectric material is Fortron® PPS SKX-382 available from Ticona, Inc.

Suitable fluoropolymer additives include, but are not necessarily limited to, polytetrafluoroethylene, perfluoroalkoxy polymer, ethylene tetrafluoroethylene copolymer, fluorinated ethylene propylene, perfluorinated poly(ethylene-propylene), and any mixture thereof. The fluoropolymers may also be copolymers of tetrafluoroethylene and ethylene and optionally a third comonomer, copolymers of tetrafluoroethylene and vinylidene fluoride and optionally a third comonomer, copolymers of chlorotrifluoroethylene and ethylene and optionally a third comonomer, copolymers of hexafluoropropylene and ethylene and optionally third comonomer, and copolymers of hexafluoropropylene and vinylidene fluoride and optionally a third comonomer. The fluoropolymer additive should have a melting peak temperature below the extrusion processing temperature, preferably about 250° C. or higher, and more preferably in the range from about 250° C. to about 340° C.

To prepare the admixture that forms the first insulating jacket 112, the fluoropolymer additive is mixed with the dielectric material prior to coating the electrical conductors. The fluoropolymer additive may be incorporated into the admixture in the amount of about 5% or less by weight based upon total weight of first insulating jacket admixture, preferably about 1% by weight based or less based upon total weight of first insulating jacket admixture, more preferably about 0.75% or less based upon total weight of first insulating jacket admixture.

Further, the second insulating jacket 114 is made of a dielectric material having a relative permittivity generally within a range of about 1.8 to about 5.0, such as polytetrafluoroethylene-perfluoromethylvinylether polymer (MFA), perfluoro-alkoxyalkane polymer (PFA), polytetrafluoroethylene polymer (PTFE), ethylene-tetrafluoroethylene polymer (ETFE), ethylene-propylene copolymer (EPC), poly(4-methyl-1-pentene) polyolefin (such as by nonlimiting example the TPX® polyolefins available from Mitsui Chemicals, Inc.), other fluoropolymers, or the like. Such dielectric materials have a lower relative permittivity than those of the dielectric materials of the first insulating jacket 112. As a result of the combination of the first insulating jacket 112 and the second insulating jacket 114, tangential electric fields are introduced and the resulting electric field has a lower intensity than in single-layer insulation.

Referring again to FIG. 1, the first insulating jacket 112 may be mechanically and/or chemically bonded to the second insulating jacket 114 so that the interface therebetween will be substantially free of voids. For example, the second insulating jacket 114 may be mechanically bonded to the first insulating jacket 112 as a result of molten or semi-molten material, forming the second insulating jacket 114, being adhered to the first insulating jacket 112. Further, the second insulating jacket 114 may be chemically bonded to the first insulating jacket 112 if the material used for the second insulating jacket 114 chemically interacts with the material of the first insulating jacket 112. The first insulating jacket 112 and the second insulating jacket 114 are capable of suppressing an electric field produced by a voltage applied to the outer conductor 110, as will be described below. The central insulated conductor 102 and the outer insulated conductors 108 are provided in a compact geometric arrangement to efficiently utilize the available diameter of the cable 100.

In the illustrated embodiment of FIG. 1, the outer insulated conductors 108 are encircled by a jacket 116 made of a material that may be either electrically conductive or electrically non-conductive and that is capable of withstanding high temperatures. Such non-conductive materials may include the polyaryletherether ketone family of polymers (PEEK, PEKK), ethylene tetrafluoroethylene copolymer (ETFE), other fluoropolymers, polyolefins, or the like. Conductive materials that may be used in the jacket 116 may include PEEK, ETFE, other fluoropolymers, polyolefins, or the like mixed with a conductive material, such as carbon black.

The volume within the jacket 116 not taken by the central insulated conductor 102 and the outer insulated conductors 108 is filled, in the illustrated embodiment, by a filler 118, which may be made of either an electrically conductive or an electrically non-conductive material. Such non-conductive materials may include ethylene propylene diene monomer (EPDM), nitrile rubber, polyisobutylene, polyethylene grease, or the like. In one embodiment, the filler 118 may be made of a vulcanizable or cross-linkable polymer. Further, conductive materials that may be used as the filler 118 may include EPDM, nitrile rubber, polyisobutylene, polyethylene grease, or the like mixed with an electrically conductive material, such as carbon black. A first armor layer 120 and a second armor layer 122, generally made of a high tensile strength material such as galvanized improved plow steel, alloy steel, or the like, surround the jacket 116 to protect the jacket 116, the non-conductive filler 118, the outer insulated conductors 108, and the central insulated conductor 102 from damage.

More than two jackets of insulation (e.g., the first insulating jacket 112 and the second insulating jacket 114) may be used according to the present invention. For example, three insulating jackets may be used, with the insulating jacket most proximate the conductor having the highest relative permittivity and the insulating jacket most distal from the conductor having the lowest relative permittivity.

In a test conducted to verify the effect of using a two layer insulation as described above, ten samples of a 22 AWG copper conductor were overlaid with a 0.051 mm-thick jacket of PEEK followed by a 0.203 mm-thick jacket of MFA, which has a lower relative permittivity than that of PEEK. Similarly, ten samples of a 14 AWG copper conductor were overlaid with a 0.051 mm-thick jacket of PEEK followed by a 0.438 mm-thick jacket of MFA. An additional ten samples of a 22 AWG copper conductor were overlaid with a single 0.254 mm-thick jacket of MFA. Further, ten samples of a 14 AWG copper conductor were overlaid with a single 0.489 mm-thick jacket of MFA. Thus, in each of the corresponding sample sets, the conductor size and the overall insulation thickness were kept constant. The inception voltage, i.e., the voltage at which partial discharge occurred, was measured for each sample, as well as the extinction voltage, i.e., the voltage at which the partial discharges ceased. An average inception voltage was determined for each of the sample sets, which generally indicates the maximum voltage that can be handled by the jacketed conductor. Further, a minimum extinction voltage was determined for each of the sample sets, which generally indicates the voltage below which no partial discharges should occur. The test results are as follows:

| Conductor | Insulation | Minimum Extinction | Average Inception |
|---|---|---|---|
| Type | Type | Voltage | Voltage |
| 22 AWG | PEEK/MFA | 1.2 kV | 2.52 kV |
| 22 AWG | MFA | 0.5 kV | 1.30 kV |
| 14 AWG | PEEK/MFA | 1.3 kV | 3.18 kV |
| 14 AWG | MFA | 1.0 kV | 1.92 kV |

Thus, in this test, the average inception voltage for PEEK/MFA-jacketed conductors was over 1000 volts greater than the average inception voltage for MFA-jacketed conductors.

Further, in certain transmission modes, cable with PEEK/MFA-jacketed conductors experienced less signal transmission loss than conventionally jacketed conductor cables.

However, the first insulating jacket 112 is also capacitive, i.e., capable of storing an electrical charge. This charge may attenuate the electrical current flowing through the outer conductor 110, since the charge leaks from the dielectric material into the surrounding cable structure over time. Such attenuation may cause a decreased amount of electrical power to be delivered through the outer conductor 110 and/or cause electrical data signals flowing through the outer conductor 110 to be corrupted. Thus, the thickness and/or the relative permittivity of the first insulating jacket 112 must be managed to provide electric field suppression while providing an acceptably low level of capacitance. For example, an acceptable capacitance of the jacketed conductor may be within the range of about one picofarad to about eight picofarads. In one embodiment, the first insulating jacket 112 has a relative permittivity only slightly greater than that of the second insulating jacket 114, so that a small increase in capacitance is produced while achieving suppression of the electric field. In one embodiment of the present invention, the first insulating jacket 112 has a thickness within a range of about 0.051 mm to about 0.153 mm.

By suppressing the electric field produced by the voltage applied to the outer conductor 110, the voltage rating of the outer conductor 110 may be increased, as evidenced by the test data presented above. If the voltage rating of a conventionally insulated conductor (e.g., the MFA-insulated conductors of the test presented above, or the like) is acceptable, for example, the diameter of the outer conductor 110 may be increased while maintaining a substantially equivalent overall insulation diameter, such that its current carrying capability is increased. In this way, larger amounts of power may be transmitted over each of the outer conductors 110, thus eliminating the need for using the armor layers 120, 122 for carrying return power in certain situations.

The central insulated conductor 102, as illustrated in FIG. 1, includes only the insulating jacket 106 of lower relative permittivity material similar to that of the second insulating jacket 114 of the outer insulated conductor 108. In certain circumstances, there may be insufficient space between the outer insulated conductors 108 to add even a thin insulating jacket (e.g., the first insulating jacket 112 of the outer insulated conductor 108, or the like). Thus, in this embodiment, no higher relative permittivity insulating jacket is provided. The scope of the present invention, however, encompasses a central insulated conductor 102 having a makeup comparable to that of the outer insulated conductors 108.

According to the present invention, the central insulated conductor 102 and each of the outer insulated conductors 108 may carry electrical power, electrical data signals, or both. In one embodiment, the central insulated conductor 102 is used to carry only electrical data signals, while the outer insulated conductors 108 are used to carry both electrical power and electrical data signals. For example, three of the outer insulated conductors 108 may be used to transmit electrical power to the one or more devices attached thereto, while the other three are used as paths for electrical power returning from the device or devices. Thus, in this embodiment, the first armor layer 120 and the second armor layer 112 may not be needed for electrical power return.

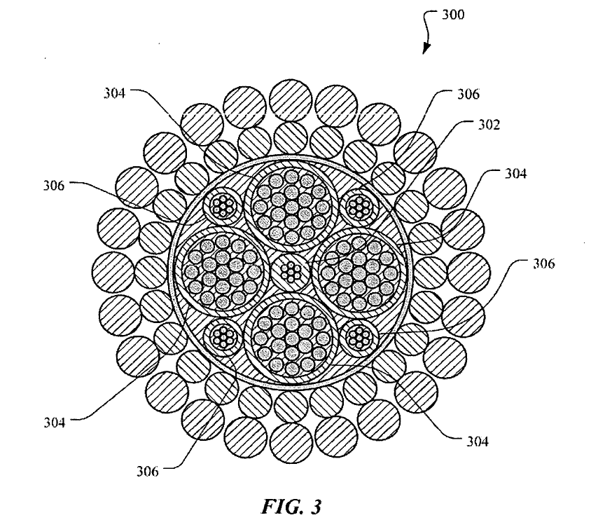

A cable according to the present invention may have many configurations that are different from the configuration of the cable 100 shown in FIG. 1. For example, FIG. 3 illustrates a second embodiment of the present invention. A cable 300 has a central insulated conductor 302 that is comparable to the central insulated conductor 102 of the first embodiment shown in FIG. 1. Surrounding the central conductor 302 are four large insulated conductors 304 and four small insulated conductors 306. In the illustrated embodiment, each of the large insulated conductors 304 and the small insulated conductors 306 are comparable to the outer insulated conductors 108 of the first embodiment illustrated in FIGS. 1 and 2. While particular cable configurations have been presented herein, cables having other quantities and configurations of conductors are within the scope of the present invention.

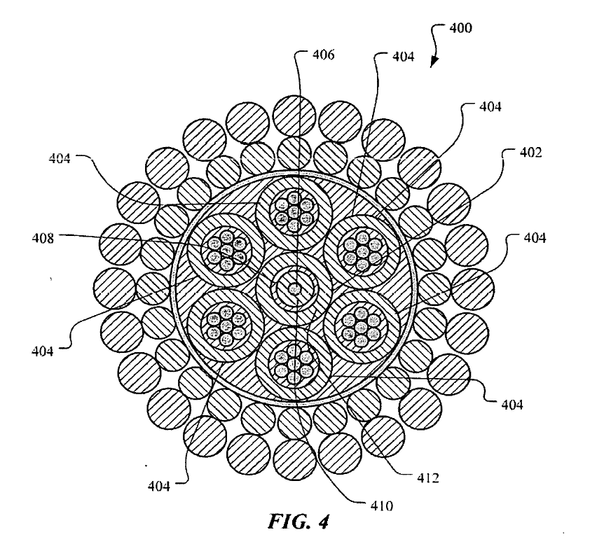

The present invention is not limited, however, to cables having only electrical conductors. FIG. 4 illustrates a third embodiment of the present invention that is comparable to the first embodiment (shown in FIG. 1) except that the central conductor 102 of the first embodiment has been replaced with a fiber optic assembly 402. In the illustrated embodiment, outer insulated conductors 404 are used to transmit electrical power to and from the device or devices attached thereto and the fiber optic assembly 402 is used to transmit optical data signals to and from the device or devices attached thereto. In certain situations, the use of the fiber optic assembly 402 to carry data signals, rather than one or more electrical conductors (e.g., the central insulated conductor 102, the outer insulated conductors 108, or the like), may result in higher transmission speeds, lower data loss, and higher bandwidth.

In the embodiment illustrated in FIG. 4, the fiber optic assembly 402 includes a fiber optic bundle 406 surrounded by a protective jacket 408. The protective jacket 408 may be made of any material capable of protecting the fiber optic bundle 406 in the environment in which the cable 400 is used, for example, stainless steel, nickel alloys, or the like. Additionally, the protective jacket 408 may be wrapped with copper tape, braid, or serve (not shown), or small diameter insulated wires (e.g. 26 or 28 AWG) (not shown) may be served around the protective jacket 408. In the illustrated embodiment, a filler material 410 is disposed between the fiber optic bundle 406 and the protective jacket 408 to stabilize the fiber optic bundle 406 within the protective jacket 408. The filler material 410 may be made of any suitable material, such as liquid or gelled silicone or nitrile rubber, or the like. An insulating jacket 412 surrounds the protective jacket 408 to electrically insulate the protective jacket 408. The insulating jacket 412 may be made of any suitable insulator, for example PTFE, EPDM, or the like.

In one application of the present invention, the cables 100, 300, 400 are used to interconnect well logging tools, such as gamma-ray emitters/receivers, caliper devices, resistivity-measuring devices, neutron emitters/receivers, and the like, to one or more power supplies and data logging equipment outside the well. Thus, the materials used in the cables 100, 300, 400 are, in one embodiment, capable of withstanding conditions encountered in a well environment, such as high temperatures, hydrogen sulfide-rich atmospheres, and the like.

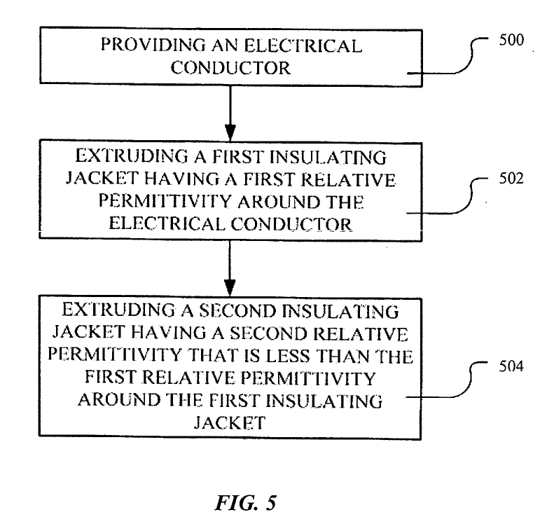

FIG. 5 illustrates a method for manufacturing an insulated conductor according to the present invention. The method includes providing an electrical conductor (block 500), extruding a fluoropolymer containing first insulating jacket having a first relative permittivity around the electrical conductor (block 502) and extruding a second insulating jacket having a second relative permittivity that is less than the first relative permittivity around the first insulating jacket (block 504). The relative permittivity values and thicknesses of the first insulating jacket and the second insulating jacket may be commensurate with those described previously. The fluoropolymer containing first insulating jacket may be placed around the electrical conductor by using a compression extrusion method, a tubing extrusion method, or by coating, while the second insulating jacket may be extruded around the first insulating jacket by a tubing extrusion method, a compression extrusion method, or a semi-compression extrusion method. The extrusion temperature is typically from about 340° C. or higher.

For example, a conductor stored on a spool may be paid out through a first extrusion device to apply a first insulating jacket (e.g., the first insulating jacket 112 of FIG. 2). A second insulating jacket (e.g., the second insulating jacket 114 of FIG. 2) is then applied around the first insulating jacket by a second extrusion device.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values. Accordingly, the protection sought herein is as set forth in the claims below.

1-31. (canceled)

32. A method for manufacturing a cable comprising:
(a) providing an electrical conductor;
(b) extruding a first insulating jacket having a first relative permittivity over the electrical conductor, wherein the first insulating jacket is prepared from an admixture comprising:
(i) a dielectric material selected from the group consisting of polyaryletherether ketone polymer, polyphenylene sulfide polymer, polyether ketone polymer, maleic anhydride modified polymers, SRP polymers, and any mixtures thereof; and,
(ii) an effective amount of a fluoropolymer processing additive to avoid forming lumps in the first insulation jacket;
(c) extruding a second insulating jacket having a second relative permittivity over the electrical conductor, wherein the second relative permittivity is less than the first relative permittivity.

33. A method according to claim 32, wherein extruding the first insulating jacket further comprises compression extruding the first insulating jacket over the electrical conductor.

34. A method according to claim 32, wherein extruding the second insulating jacket further comprises extruding the second insulating jacket over the electrical conductor by a method selected from the group consisting of tubing extrusion, compression extrusion, and semi-compression extrusion.

35. A method according to claim 32, wherein extruding the second insulating jacket further comprises extruding the second insulating jacket over the electrical conductor such that the second insulating jacket is mechanically bonded to the first insulating jacket.

36. A method according to claim 32, wherein extruding the second insulating jacket further comprises extruding the second insulating jacket over the electrical conductor such that the second insulating jacket is chemically bonded to the first insulating jacket.

37. A method according to claim 32, wherein the first insulating jacket and the second insulating jacket are separately extruded by tandem extrusion.

38. A method according to claim 32, wherein the fluoropolymer processing additive is incorporated in the amount of about 5% or less by weight based upon total weight of first insulating jacket admixture.

39. A method according to claim 38, wherein the fluoropolymer processing additive is incorporated in the amount of about 1% or less by weight based upon total weight of first insulating jacket admixture.

40. A method according to claim 39, wherein the fluoropolymer processing additive is incorporated in the amount of about 0.75% or less by weight based upon total weight of first insulating jacket admixture.

41. A method according to claim 32, wherein the fluoropolymer processing additive is selected from the group consisting of polytetrafluoroethylene, perfluoroalkoxy polymer, fluorinated ethylene propylene, ethylene tetrafluoroethylene copolymer, and any mixture thereof.

42. A method according to claim 32, wherein the fluoropolymer processing additive has a melting peak temperature in the range from about 250° C. to about 340° C.

43. A method according to claim 32, wherein the fluoropolymer processing additive is polytetrafluoroethylene.

44. A method according to claim 32, wherein the first relative permittivity is within a range of about 2.5 to about 10.0, and wherein the second relative permittivity is within a range of about 1.8 to about 5.0.

45. A method according to claim 32, wherein a thickness of the first insulating jacket is within a range of about 0.051 mm to about 0.153 mm.

46. A method according to claim 32, wherein the second insulating jacket is made of a material selected from the group consisting of polytetrafluoroethylene-perfluoromethylvinylether polymer, perfluoro-alkoxyalkane polymer, polytetrafluoroethylene polymer, ethylene-tetrafluoroethylene polymer, ethylene-propylene copolymer, polyethylene, poly(4-methyl-1-pentene) polyolefin, and fluoropolymer.

47. A method according to claim 32, further comprising: surrounding the second insulating jacket with a jacket, and disposing an optional filler between the jacket and the second insulating jacket.

48. A method according to claim 47, further comprising an armor layer surrounding the jacket.

49. A method according to claim 47, wherein the jacket is an electrically non-conductive jacket made from a material selected from the group consisting of the polyaryletherether ketone family of polymers, ethylene tetrafluoroethylene copolymer, fluoropolymer, and polyolefin.

50. A method according to claim 47, wherein the optional filler is an electrically non-conductive filler made from a material selected from the group consisting of ethylene propylene diene monomer, nitrile rubber, polyisobutylene, and polyethylene grease.

51. A method according to claim 32, wherein a capacitance of the electrical conductor in combination with the first insulating jacket and the second insulating jacket is within the range of about one picofarad to about eight picofarads.
